(19) United States
(12) Patent Application Publication
(10) Pub. No.: US 2020/0192286 A1
(43) Pub. Date: Jun. 18, 2020

(54) HOLOGRAM IMAGE REPRESENTATION METHOD AND HOLOGRAM IMAGE REPRESENTATION DEVICE

(71) Applicant: Electronics and Telecommunications Research Institute, Daejeon (KR)

(72) Inventor: Kwan-Jung OH, Daejeon (KR)

(73) Assignee: Electronics and Telecommunications Research Institute, Daejeon (KR)

(21) Appl. No.: 16/704,907

(22) Filed: Dec. 5, 2019

(30) Foreign Application Priority Data
Dec. 13, 2018 (KR) 10-2018-0161271
Dec. 3, 2019 (KR) 10-2019-0159221

(51) Int. Cl. G03H 1/08; G06T 7/254

(52) U.S. Cl. CPC G03H 1/0808; G06T 7/254; G06T 2207/10028; G03H 2001/0825; G03H 2210/30

(57) ABSTRACT

Provided are a hologram image representation method and a hologram image representation device. A hologram image representation method comprising: receiving a three-dimensional input image including depth information; obtaining a plurality of input image layers from the three-dimensional input image based on the depth information; generating a plurality of Computer Generated Hologram (CGH) image layers by performing CGH processing on each of the plurality of input image layers; and representing a hologram image using the plurality of CGH image layers.

### CROSS-REFERENCE TO RELATED APPLICATION

This application claims priority under 35 U.S.C. § 119 to Korean Patent Application No. 10-2018-0161271, filed Dec. 13, 2018, and Korean Patent Application No. 10-2019-0159221, filed Dec. 3, 2019, in the Korean Intellectual Property Office, the disclosures of which are incorporated herein by reference in their entirety.

### BACKGROUND

### (a) Technical Field

The present disclosure relates to a hologram image representation method and a hologram image representation device.

### (b) Description of the Related Art

Holography is a technique that uses diffraction and interference of light. Unlike two-dimensional images that store only amplitude information of light, holography can utilize phase information of light. Accordingly, holography can provide a perfect three-dimensional image such as viewing a real object. Recently, researches on digital hologram technology, which generate a hologram image by using Computer Generated Hologram (CGH) technology for a general image (or input image), is actively conducted.

When the input image is a three-dimensional image, the input image may include depth information about objects displayed on the input image, and the objects may be distinguished according to the depth information. However, when a single hologram is generated by applying CGH to image objects that can be distinguished according to depth information, processing such as three-dimensional image editing, image transformation, and the like, is not easy for the generated single hologram.

### SUMMARY

Aspects of the present disclosure provide a hologram image representation method and a hologram image representation device capable of facilitating a three-dimensional image processing for a hologram image by representing a plurality of CGH images for each layer that reflects depth information with respect to the three-dimensional input image.

The aspects of the present disclosure are not restricted to those mentioned above, and another aspect which is not mentioned will be clearly understood by a person skilled in the art from the description below.

According to an aspect of the present disclosure, there is provided a hologram image representation method including: receiving a three-dimensional input image including depth information; obtaining a plurality of input image layers from the three-dimensional input image based on the depth information; generating a plurality of Computer Generated Hologram (CGH) image layers by performing CGH processing on each of the plurality of input image layers; and representing a hologram image using the plurality of CGH image layers.

The hologram image may include a plurality of pixels, and each of the plurality of pixels includes one or more hologram information.

A first pixel of the plurality of pixels may include hologram information for one CGH image layer of the plurality of CGH image layers.

A second pixel of the plurality of pixels may include hologram information for two or more CGH image layers of the plurality of CGH image layers.

A first pixel of the plurality of pixels may include hologram information for a first CGH image layer of the plurality of CGH image layers, and a second pixel of the plurality of pixels may include hologram information for the first CGH image layer and a second CGH image layer of the plurality of CGH image layers.

The method may further include editing the plurality of CGH image layers.

The editing the plurality of CGH image layers may include removing at least one CGH image layer from the plurality of CGH image layers.

The editing the plurality of CGH image layers may include changing an order of layers of some CGH image layers from the plurality of CGH image layers.

The method may further include performing random phase modulation on the plurality of CGH image layers.

According to another aspect of the present disclosure, there is provided a hologram image representation method including: receiving a three-dimensional input image including depth information; obtaining a plurality of input image layers from the three-dimensional input image based on the depth information; generating a plurality of CGH image layers by performing CGH processing on each of the plurality of input image layers; and editing the plurality of CGH image layers.

The method may further include representing a hologram image using edited the plurality of CGH image layers.

The editing the plurality of CGH image layers may include removing at least one CGH image layer from the plurality of CGH image layers.

The editing the plurality of CGH image layers may include changing an order of layers of some CGH image layers from the plurality of CGH image layers.

The hologram image may include a plurality of pixels, and each of the plurality of pixels may include one or more hologram information.

A first pixel of the plurality of pixels may include hologram information for a first CGH image layer of the plurality of CGH image layers, and a second pixel of the plurality of pixels may include hologram information for the first CGH image layer and a second CGH image layer of the plurality of CGH image layers.

According to still another aspect of the present disclosure, there is provided a hologram image representation device including: an image input module configured to receive a three-dimensional input image including depth information; an input image layer obtaining module configured to obtain a plurality of input image layers from the three-dimensional input image based on the depth information; a CGH image layer generating module configured to generate a plurality of CGH image layers by performing CGH processing on each of the plurality of input image layers; and a hologram image representing module configured to represent a hologram image using the plurality of CGH image layers.

The hologram image may include a plurality of pixels, and each of the plurality of pixels includes one or more hologram information.

A first pixel of the plurality of pixels may include hologram information for a first CGH image layer of the plurality of CGH image layers, and a second pixel of the plurality of pixels may include hologram information for the first CGH image layer and a second CGH image layer of the plurality of CGH image layers.

The device may further include an editing module configured to edit the plurality of CGH image layers.

The device may further include a modulating module configured to perform random phase modulation on the plurality of CGH image layers.

According to embodiments of the present disclosure, one pixel of a hologram image may include one or more hologram information obtained from CGH images to which CGH is individually applied according to depth information of a three-dimensional input image. As such, even after the hologram image has been generated, it is possible to perform three-dimensional image processing on the hologram image.

In addition, according to embodiments of the present disclosure, by representing random phases by each depth or object, it is possible to separate random phase process into either pre-processing process or post-processing process, so that a hologram can be more easily edited, compressed, transmitted and the like.

In addition, according to embodiments of the present disclosure, before the hologram image is finally generated, extracting only a desired portion from the plurality of CGH image layers, changing relationships between the layers in a desired direction, or even receiving an additional layer provided from the outside and adding the additional layer to the plurality of CGH image layers may also be performed, so that three-dimensional image processing on the hologram image can be easily performed.

### DETAILED DESCRIPTION

The above and other aspects and features of the present disclosure will become more apparent by describing in detail example embodiments thereof with reference to the attached drawings, in which:

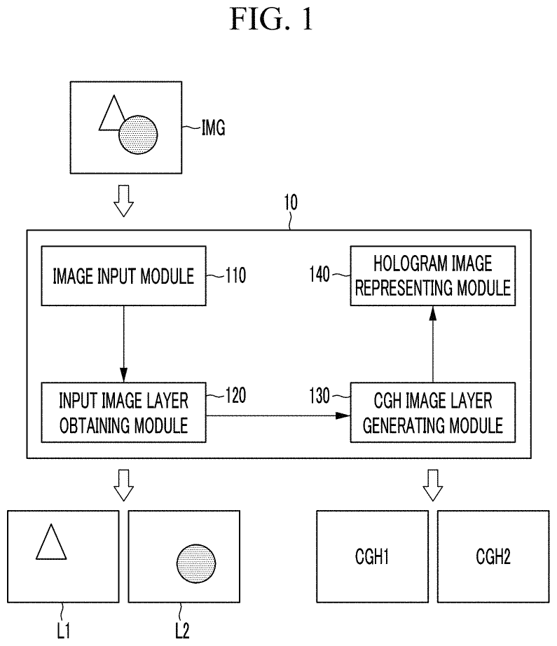

FIG. 1 is a block diagram illustrating a hologram image representation device according to an embodiment of the present disclosure;

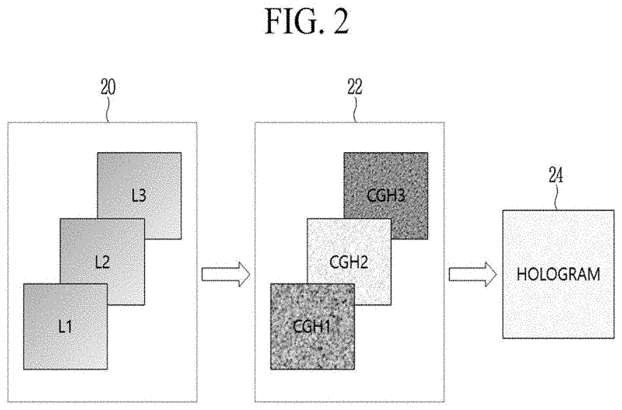

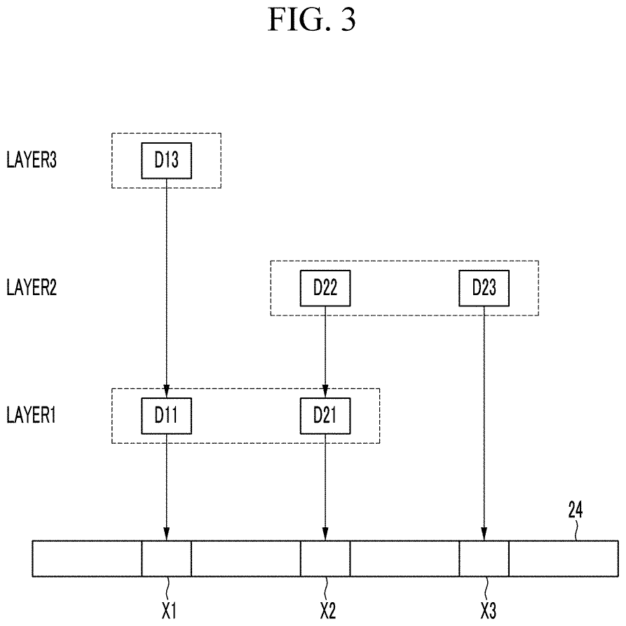

FIGS. 2 to 3 illustrate operations of a hologram image representation device according to an embodiment of the present disclosure;

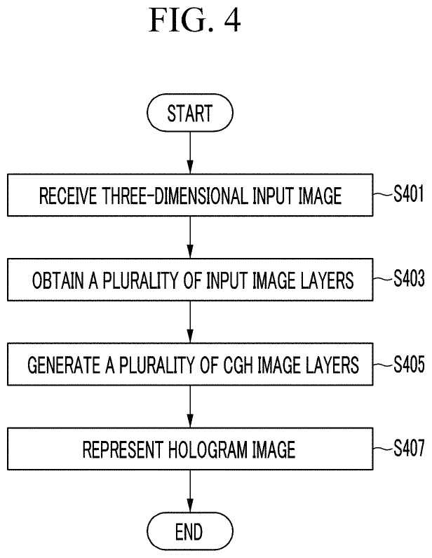

FIG. 4 is a flowchart illustrating a hologram image representation method according to an embodiment of the present disclosure;

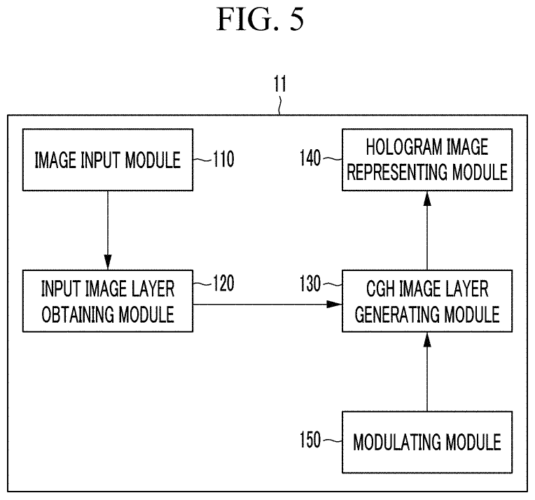

FIG. 5 is a block diagram illustrating a hologram image representation device according to an embodiment of the present disclosure;

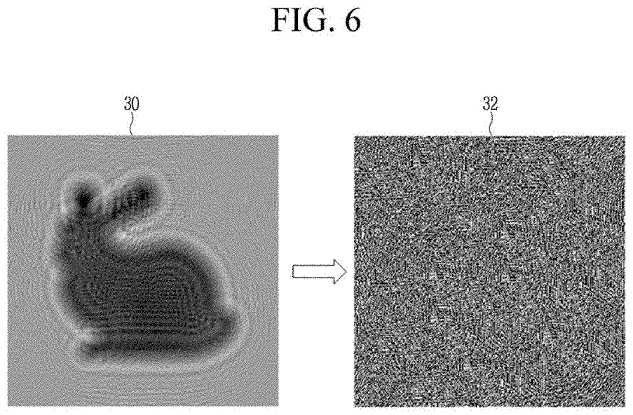

FIG. 6 illustrates operations of a hologram image representation device according to an embodiment of the present disclosure;

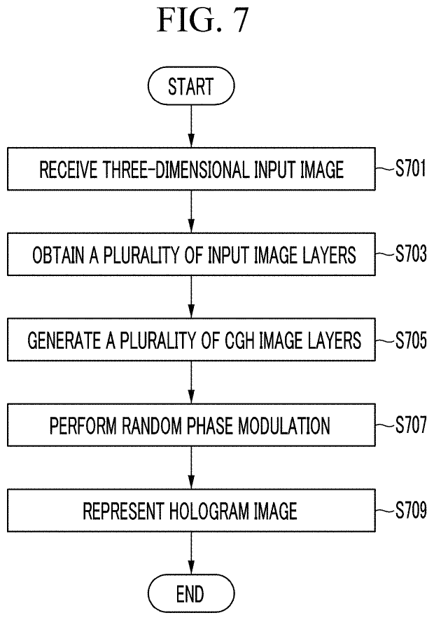

FIG. 7 is a flowchart illustrating a hologram image representation method according to an embodiment of the present disclosure;

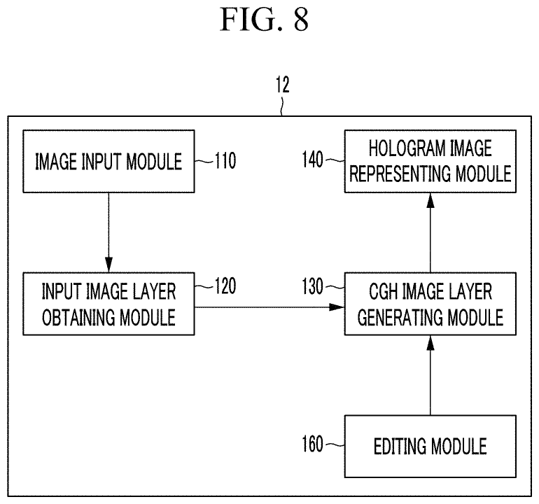

FIG. 8 is a block diagram illustrating a hologram image representation device according to an embodiment of the present disclosure;

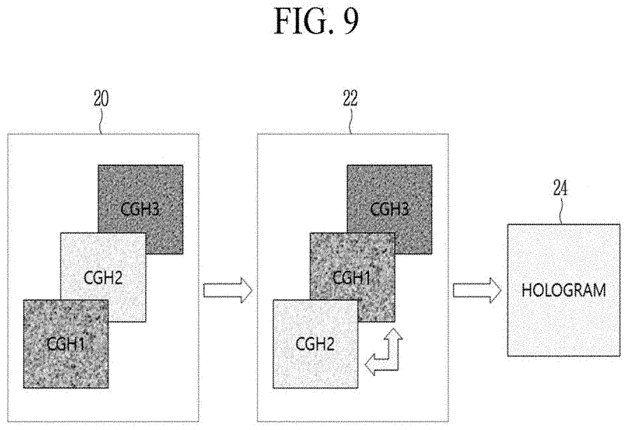

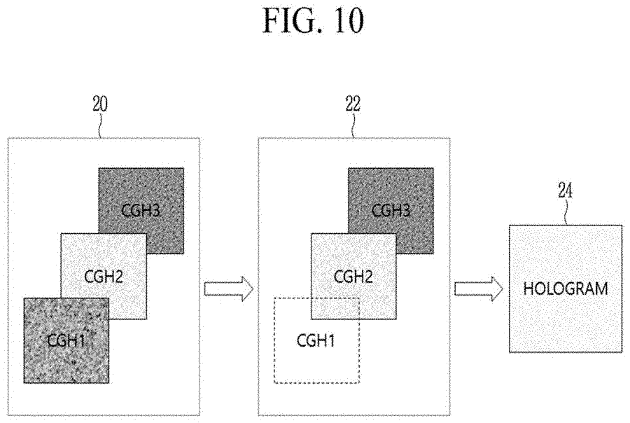

FIGS. 9 to 10 illustrate operations of a hologram image representation device according to an embodiment of the present disclosure;

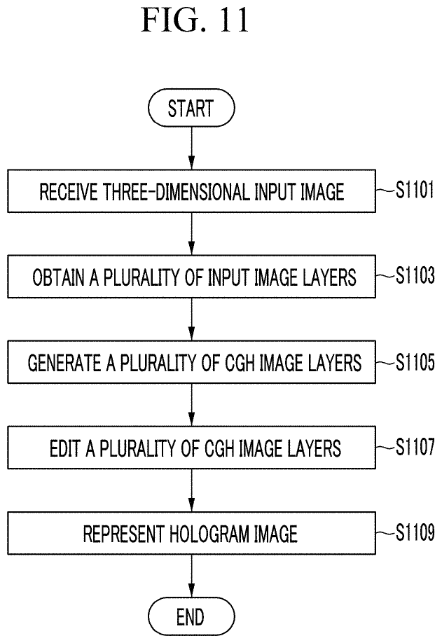

FIG. 11 is a flowchart illustrating a hologram image representation method according to an embodiment of the present disclosure; and

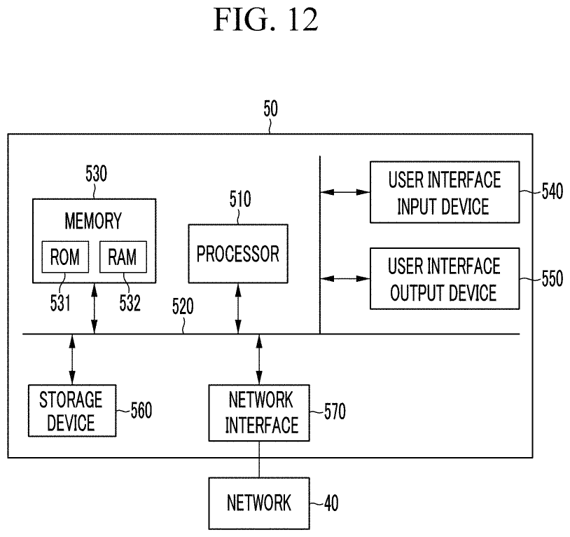

FIG. 12 is a block diagram illustrating a computing device for implementing a hologram image representation method and a hologram image representation device according to an embodiment of the present disclosure.

### DETAILED DESCRIPTION

Hereinafter, exemplary embodiments of the present disclosure will be described in detail with reference to the accompanying drawings so that those skilled in the art may easily implement the present disclosure. As those skilled in the art would realize, the described embodiments may be modified in various different ways, all without departing from the spirit or scope of the present disclosure. In the drawings, parts irrelevant to the description are omitted in order to clearly describe the present disclosure, and like reference numerals designate like parts throughout the specification.

Throughout the specification and claims, when a portion is said to “include” a certain component, it means that it can further include other components, except to exclude other components unless specifically stated otherwise.

In addition, the terms “unit,” “module,” etc. described in the specification mean a unit that processes at least one function or operation, which can be implemented using hardware or software or a combination of hardware and software.

Now, a hologram image representation method and a hologram image representation device according to embodiments of the present disclosure will be described in detail with reference to the drawings.

FIG. 1 is a block diagram illustrating a hologram image representation device according to an embodiment of the present disclosure.

Referring to FIG. 1, the hologram image representation device 10 according to an embodiment of the present disclosure may generate CGH images through CGH processing on the input image IMG and generate hologram images that can be viewed in a virtual three-dimensional space from the generated CGH images.

Holography is a kind of three-dimensional spatial representation technology that has no limitation for a field of view and little stereoscopic fatigue, by reproducing objects in a three-dimensional space by controlling amplitudes and phases of light. A hologram can be displayed on a three-dimensional space using interference patterns of object waves and reference waves, and a device capable of simultaneously controlling amplitudes and phases of light such as a complex Spatial Light Modulator (SLM) can implement real-time high-resolution holograms. Recently, CGH technology has also been utilized to provide holograms on flat panel displays by processing interference patterns for playing holographic videos.

Here, the CGH technology may be defined as including a series of processes from the input image IMG to the generation of the CGH images, and the hologram image may include a still image or a playable video.

Specifically, the CGH technology can generate holograms by approximating optical signals and calculating interference patterns generated through mathematical operations. For example, based on the fact that a three-dimensional object is composed of a set of three-dimensional points, the CGH technology calculates a point hologram corresponding to each of all three-dimensional points constituting the three-dimensional object, thereby representing a complete hologram, however, the scope of the present disclosure is not limited thereto.

When the input image IMG is a three-dimensional image, the input image IMG may include depth information about objects displayed on the image, and the objects may be distinguished according to the depth information. The hologram image representation device 10 according to an embodiment of the present disclosure generates a plurality of CGH images for each layer that reflects depth information with respect to the three-dimensional input image IMG, and represents a hologram image therefrom, thus it is possible to facilitate three-dimensional image processing on the hologram image.

To this end, the hologram image representation device 10 may include an image input module 110, an input image layer obtaining module 120, a CGH image layer generating module 130, and a hologram image representing module 140.

The image input module 110 may receive a three-dimensional input image IMG including depth information and transmit it to the input image layer obtaining module 120. As described above, the input image IMG may include depth information about the displayed objects (e.g., a circle and a triangle), and the objects may be distinguished from each other according to the depth information.

The input image layer obtaining module 120 may obtain a plurality of input image layers from the three-dimensional input image IMG based on the depth information. Since the displayed objects (e.g., the circle and the triangle) of the input image IMG may be distinguished from each other according to depth information, the input image layer obtaining module 120 may obtain an input image layer L1 corresponding to the triangle and an input image layer L2 corresponding to the circle. As such, depth information for distinguishing objects according to depth is not limited to a specific format and may be any format that the hologram image representation device 10 can read. For example, the depth information may be given by a depth image or may be given by three-dimensional image information such as a point cloud or a mesh. In this case, points or meshes having the same or similar depth in the point cloud or the mesh may be grouped into one layer.

The CGH image layer generating module 130 may generate a plurality of CGH image layers CGH1 and CGH2 by performing CGH processing on each of the plurality of input image layers L1 and L2. For example, the CGH image layer generating module 130 may generate a CGH image layer CGH1 by applying CGH to the triangle image, and a CGH image layer CGH2 by applying CGH to the circle image.

The hologram image representing module 140 may represent a hologram image that can be displayed in a virtual three-dimensional space by using the plurality of CGH image layers CGH1 and CGH2. The generated hologram image may be displayed as a real-time high-resolution hologram using a device such as a complex Spatial Light Modulator. That is, the complex Spatial Light Modulator may receive a hologram image represented using a plurality of CGH image layers CGH1 and CGH2.

FIGS. 2 to 3 illustrate operations of a hologram image representation device according to an embodiment of the present disclosure.

First, referring to FIG. 2, when the three-dimensional input image IMG includes objects distinguished by three different depths, the first result 20 generated by the input image layer obtaining module 120 may include a plurality of input image layers L1, L2, and L3. Subsequently, for the plurality of input image layers L1, L2, and L3, the second result 22 generated by the CGH image layer generating module 130 may include a plurality of CGH image layers CGH1, CGH2, CGH3. In addition, the final result 24 generated by the hologram image representing module 140 may correspond to the hologram image.

Here, the hologram image may include a plurality of pixels, and each of the plurality of pixels may include one or more hologram information (or digital hologram data). For example, the hologram information may be represented as a complex value having a real part and an imaginary part, but the scope of the present disclosure is not limited thereto, and as methods of representing digital hologram data may be referred to known technologies, detailed descriptions thereof will be omitted herein.

Next, referring to FIG. 3, a first pixel of the plurality of pixels of the hologram image may include hologram information for one CGH image layer from the plurality of CGH image layers. For example, the pixel X3 of the plurality of pixels of the hologram image 24 may include hologram information D23 for one CGH image layer LAYER2 among the plurality of CGH image layers LAYER1, LAYER2, and LAYER3.

Meanwhile, a second pixel of the plurality of pixels of the hologram image may include hologram information for two or more CGH image layers from the plurality of CGH image layers. For example, the pixel X1 of the plurality of pixels of the hologram image 24 may include hologram information D11 and D13 for the CGH image layer LAYER1 and the CGH image layer LAYER3 among the plurality of CGH image layers LAYER1, LAYER2, and LAYER3. Alternatively, the pixel X2 of the plurality of pixels of the hologram image 24 may include hologram information D21 and D22 for the CGH image layer LAYER1 and the CGH image layer LAYER2 among the plurality of CGH image layers LAYER1, LAYER2, and LAYER3.

Meanwhile, a first pixel of the plurality of pixels of the hologram image may include hologram information for a first CGH image layer of the plurality of CGH image layers, and a second pixel of the plurality of pixels may include hologram information for the first CGH image layer and a second CGH image layer of the plurality of CGH image layers. For example, the pixel X3 of the plurality of pixels of the hologram image 24 may include hologram information D23 for the CGH image layer LAYER2 among the plurality of CGH image layers LAYER1, LAYER2, and LAYER3, and the pixel X2 of the plurality of pixels may include hologram information D22 and D21 for the CGH image layer LAYER2 and the CGH image layer LAYER1 among the plurality of CGH image layers LAYER1, LAYER2, and LAYER3.

Here, when one pixel includes a plurality of hologram information, the hologram information may be implemented using any data structure such as a linked list.

According to the present embodiment, one pixel of the hologram image 24 may include one or more hologram information obtained from CGH images to which CGH is individually applied according to depth information of a three-dimensional input image. As such, even after the hologram image 24 has been generated, it is possible to perform three-dimensional image processing on the hologram image 24.

Here, the three-dimensional image processing may mean image editing or transformation such as removing at least some of the objects distinguished by depths, or swapping objects corresponding to different depths in the three-dimensional image. Of course, such three-dimensional image processing is not only possible after the hologram image 24 is generated, but also possible at a stage before the plurality of CGH image layers generated by the CGH image layer generation module 130 are converted into the hologram image 24. Details thereof will be described later with reference to FIGS. 8 to 11.

FIG. 4 is a flowchart illustrating a hologram image representation method according to an embodiment of the present disclosure.

Referring to FIG. 4, the hologram image representation method according to an embodiment of the present disclosure may include receiving a three-dimensional input image including depth information (S401).

In addition, the method may include obtaining a plurality of input image layers from the three-dimensional input image based on the depth information (S403).

In addition, the method may include generating a plurality of CGH image layers by performing CGH processing on each of the plurality of input image layers (S405).

In addition, the method may include representing a hologram image using the plurality of CGH image layers (S407).

For more details about the steps S401 to S407, reference may be made to the image input module 110, the input image layer obtaining module 120, the CGH image layer generating module 130 and the hologram image representing module 140 of the image presentation device 10 described with reference to FIG. 1, and thus redundant descriptions thereof will be omitted.

FIG. 5 is a block diagram illustrating a hologram image representation device according to an embodiment of the present disclosure, and FIG. 6 illustrates operations of a hologram image representation device according to an embodiment of the present disclosure.

Referring to FIG. 5, the hologram image representation device 11 according to an embodiment of the present disclosure may include an image input module 110, an input image layer obtaining module 120, a CGH image layer generating module 130, a hologram image representing module 140 and a modulating module 150. As details on the image input module 110, the input image layer obtaining module 120, the CGH image layer generating module 130, and the hologram image representing module 140 may be described with reference to FIGS. 1 to 3, redundant descriptions thereof will be omitted.

The modulating module 150 may perform random phase modulation on the plurality of CGH image layers. Specifically, the modulating module 150 may perform random phase modulation on the plurality of CGH image layers generated after the CGH image layer generating module 130 performs CGH processing on the plurality of input image layers generated by the input image layer obtaining module 120.

Referring to FIG. 6 together, the image 30 may correspond to a CGH image layer, and the image 32 may correspond to a result of performing random phase modulation on the CGH image layer.

The random phase modulation represents the surface of the object to be finely rough, so that light reaching the surface of the object may spread in various directions. In the case of holograms, considering the random phase, the holograms can be viewed with uniform image quality within a given viewing angle. In contrast, if the random phase is not considered, holograms can be viewed in an axial direction, but it becomes more difficult to view the holograms toward the outer region within the viewing angle. In addition, the random phase can also enhance the effect of accommodation, which is one of the main features of holograms. However, the random phase may cause speckle noise and reduce the spatial correlation of the hologram itself.

According to the present embodiment, by representing random phases by each depth or object, it is possible to separate random phase process into either pre-processing process or post-processing process, so that a hologram can be more easily edited, compressed, transmitted and the like.

FIG. 7 is a flowchart illustrating a hologram image representation method according to an embodiment of the present disclosure.

Referring to FIG. 7, the hologram image representation method according to an embodiment may include receiving a three-dimensional input image including depth information (S701).

In addition, the method may include obtaining a plurality of input image layers from the three-dimensional input image based on the depth information (S703).

In addition, the method may include generating a plurality of CGH image layers by performing CGH processing on each of the plurality of input image layers (S705).

In addition, the method may include performing random phase modulation on the plurality of CGH image layers (S707).

In addition, the method may include representing a hologram image using the plurality of CGH image layers on which the random phase modulation is performed (S709).

For more details about the steps S701 to S709, reference may be made to the image input module 110, the input image layer obtaining module 120, the CGH image layer generating module 130, the hologram image representing module 140 and the modulating module 150 of the image presentation device 10 described with reference to FIG. 5, and thus redundant descriptions thereof will be omitted.

FIG. 8 is a block diagram illustrating a hologram image representation device according to an embodiment of the present disclosure, and FIGS. 9 to 10 illustrate operations of a hologram image representation device according to an embodiment of the present disclosure.

Referring to FIG. 8, the hologram image representation device 12 according to an embodiment of the present disclosure may include an image input module 110, an input image layer obtaining module 120, a CGH image layer generating module 130, and a hologram image representing module 140 and an editing module 160. As details of the image input module 110, the input image layer obtaining module 120, the CGH image layer generating module 130, and the hologram image representing module 140 may be described with reference to FIGS. 1 to 3, redundant descriptions thereof will be omitted.

The editing module 160 may edit the plurality of CGH image layers. Specifically, the editing module 160 may edit the plurality of CGH image layers generated after the CGH image layer generating module 130 performs CGH processing on the plurality of input image layers generated by the input image layer obtaining module 120.

Here, the editing of the plurality of CGH image layers may mean editing such as changing an order of layers of some CGH image layers from the plurality of CGH image layers or removing at least one CGH image layer from the plurality of CGH image layers. However, the scope of the present disclosure is not limited thereto, and it may include all of the various editings corresponding to general video editings not illustrated herein.

Referring to FIG. 9, for example, the editing module 160 may change the order of layers of some CGH image layers CGH1 and CGH2 from the plurality of CGH image layers CGH1, CGH2, and CGH3. Specifically, it can be seen that the order of layers is changed so that the depth of the CGH image layer CGH1 is changed from the foreground side to the background side, and the depth of the CGH image layer CGH2 is changed from the background side to the foreground side.

Thereafter, the hologram image 24 may be generated based on the plurality of CGH image layers having an order of layers different from that of the plurality of CGH image layers generated by the CGH image layer generating module 130.

Next, referring to FIG. 10, for example, the editing module 160 may remove at least one CGH image layer CGH1 from the plurality of CGH image layers CGH1, CGH2, and CGH3.

Thereafter, the hologram image 24 may be generated based on the plurality of CGH image layers having fewer layers than the plurality of CGH image layers generated by the CGH image layer generating module 130.

According to the present embodiment, before the hologram image 24 is finally generated, extracting only a desired portion from the plurality of CGH image layers CGH1, CGH2, and CGH3, changing relationships between the layers in a desired direction, or even receiving an additional layer provided from the outside and adding the additional layer CGH4 to the plurality of CGH image layers CGH1, CGH2, and CGH3 may also be performed, so that three-dimensional image processing on the hologram image can be easily performed.

Of course, such image processing may be performed even after the hologram image 24 is finally generated. As described above, one pixel of the hologram image 24 may include one or more hologram information obtained from CGH images to which CGH is individually applied according to depth information of the three-dimensional input image, according to the representation method of the hologram image 24, even after the hologram image 24 has been generated, it is possible to perform three-dimensional image processing on the hologram image 24.

FIG. 11 is a flowchart illustrating a hologram image representation method according to an embodiment of the present disclosure.

Referring to FIG. 11, the hologram image representation method according to an embodiment of the present disclosure may include receiving a three-dimensional input image including depth information (S1101).

In addition, the method may include obtaining a plurality of input image layers from the three-dimensional input image based on the depth information (S1103).

In addition, the method may include generating a plurality of CGH image layers by performing CGH processing on each of the plurality of input image layers (S1105).

In addition, the method may include editing the plurality of CGH image layers (S1107).

In addition, the method may include representing a hologram image using the edited plurality of CGH image layers (S1109).

For more details about the steps S1101 to S1109, reference may be made to the image input module 110, the input image layer obtaining module 120, the CGH image layer generating module 130, the hologram image representing module 140 and the editing module 160 of the image presentation device 10 described with reference to FIG. 8, and thus redundant descriptions thereof will be omitted.

FIG. 12 is a block diagram illustrating a computing device for implementing a hologram image representation method and a hologram image representation device according to an embodiment of the present disclosure.

Referring to FIG. 12, a hologram image representation method and a hologram image representation device according to an embodiment of the present disclosure may be implemented using a computing device 50.

The computing device 50 may include at least one of a processor 510, a memory 530, a user interface input device 540, a user interface output device 550, and a storage device 560 that communicate over a bus 520. Computing device 50 may also include a network interface 570 that is electrically connected to a network 40, such as a wireless network. The network interface 570 may send or receive signals with other entities over the network 40.

The processor 510 may be implemented in various types, such as an Application Processor (AP), a Central Processing Unit (CPU), a Graphics Processing Unit (GPU), and may be any semiconductor device that executes instructions stored in the memory 530 or the storage device 560. The processor 510 may be configured to implement the functions and methods described with reference to FIGS. 1 to 11.

The memory 530 and the storage device 560 may include various types of volatile or nonvolatile storage media. For example, the memory 530 may include Read-Only Memory (ROM) 531 and Random Access Memory (RAM) 532. In an embodiment of the present disclosure, the memory 530 may be located inside or outside the processor 510, and the memory 530 may be connected to the processor 510 through various known means.

In addition, at least some of the functions of the hologram image representation device may be implemented as a program or software executed on the computing device 50, and the program or software may be stored in a computer readable medium.

In addition, at least some of the functions of the hologram image representation device may be implemented in hardware that may be electrically connected to the computing device 50.

According to embodiments of the present disclosure, one pixel of a hologram image may include one or more hologram information obtained from CGH images to which CGH is individually applied according to depth information of a three-dimensional input image. As such, even after the hologram image has been generated, it is possible to perform three-dimensional image processing on the hologram image.

In addition, according to embodiments of the present disclosure, by representing random phases by each depth or object, it is possible to separate random phase process into either pre-processing process or post-processing process, so that a hologram can be more easily edited, compressed, transmitted and the like.

In addition, according to embodiments of the present disclosure, before the hologram image is finally generated, extracting only a desired portion from the plurality of CGH image layers, changing relationships between the layers in a desired direction, or even receiving an additional layer provided from the outside and adding the additional layer to the plurality of CGH image layers may also be performed, so that three-dimensional image processing on the hologram image can be easily performed.

Although the embodiments of the present disclosure have been described in detail above, the scope of the present disclosure is not limited thereto. Many variations and modifications of a person skilled in the art using the basic concept of the present disclosure defined in the following claims, also fall within the scope of the present disclosure.

What is claimed is:

1. A hologram image representation method comprising:
receiving a three-dimensional input image including depth information;
obtaining a plurality of input image layers from the three-dimensional input image based on the depth information;
generating a plurality of Computer Generated Hologram (CGH) image layers by performing CGH processing on each of the plurality of input image layers; and
representing a hologram image using the plurality of CGH image layers.

2. The method of claim 1, wherein the hologram image includes a plurality of pixels, and each of the plurality of pixels includes one or more hologram information.

3. The method of claim 2, wherein a first pixel of the plurality of pixels includes hologram information for one CGH image layer of the plurality of CGH image layers.

4. The method of claim 2, wherein a second pixel of the plurality of pixels includes hologram information for two or more CGH image layers of the plurality of CGH image layers.

5. The method of claim 2, wherein a first pixel of the plurality of pixels includes hologram information for a first CGH image layer of the plurality of CGH image layers, and a second pixel of the plurality of pixels includes hologram information for the first CGH image layer and a second CGH image layer of the plurality of CGH image layers.

6. The method of claim 1, further comprising:
editing the plurality of CGH image layers.

7. The method of claim 6, wherein the editing the plurality of CGH image layers comprising:
removing at least one CGH image layer from the plurality of CGH image layers.

8. The method of claim 6, wherein the editing the plurality of CGH image layers comprising:
changing an order of layers of some CGH image layers from the plurality of CGH image layers.

9. The method of claim 1, further comprising:
performing random phase modulation on the plurality of CGH image layers.

10. A hologram image representation method comprising:
receiving a three-dimensional input image including depth information;
obtaining a plurality of input image layers from the three-dimensional input image based on the depth information;
generating a plurality of CGH image layers by performing CGH processing on each of the plurality of input image layers; and
editing the plurality of CGH image layers.

11. The method of claim 10, further comprising:
representing a hologram image using edited the plurality of CGH image layers.

12. The method of claim 10, wherein the editing the plurality of CGH image layers comprising:
removing at least one CGH image layer from the plurality of CGH image layers.

13. The method of claim 10, wherein the editing the plurality of CGH image layers comprising:
changing an order of layers of some CGH image layers from the plurality of CGH image layers.

14. The method of claim 10, wherein the hologram image includes a plurality of pixels, and each of the plurality of pixels includes one or more hologram information.

15. The method of claim 14, wherein a first pixel of the plurality of pixels includes hologram information for a first CGH image layer of the plurality of CGH image layers, and a second pixel of the plurality of pixels includes hologram information for the first CGH image layer and a second CGH image layer of the plurality of CGH image layers.

16. A hologram image representation device comprising:
an image input module configured to receive a three-dimensional input image including depth information;
an input image layer obtaining module configured to obtain a plurality of input image layers from the three-dimensional input image based on the depth information;
a CGH image layer generating module configured to generate a plurality of CGH image layers by performing CGH processing on each of the plurality of input image layers; and
a hologram image representing module configured to represent a hologram image using the plurality of CGH image layers.

17. The device of claim 16, wherein the hologram image includes a plurality of pixels, and each of the plurality of pixels includes one or more hologram information.

18. The device of claim 17, wherein a first pixel of the plurality of pixels includes hologram information for a first CGH image layer of the plurality of CGH image layers, and a second pixel of the plurality of pixels includes hologram information for the first CGH image layer and a second CGH image layer of the plurality of CGH image layers.

19. The device of claim 16, further comprising:
an editing module configured to edit the plurality of CGH image layers.

20. The device of claim 16, further comprising:
a modulating module configured to perform random phase modulation on the plurality of CGH image layers.
